(19) United States
(12) Patent Application Publication
(10) Pub. No.: US 2007/0220254 A1
(43) Pub. Date: Sep. 20, 2007

(54) Secure digital memory devices and controllers thereof

(75) Inventor: Yen-Hsin Liu, Miaoli County (TW)

Correspondence Address: BIRCH STEWART KOLASCH & BIRCH, PO BOX 747, FALLS CHURCH, VA, 22040-0747, US

(73) Assignee: A-DATA TECHNOLOGY CO.

(21) Appl. No.: 11/496,626

(22) Filed: Aug. 1, 2006

(30) Foreign Application Priority Data
Mar. 15, 2006 (TW) 095108689

(51) Int. Cl. H04L 9/00

(52) U.S. Cl. 713/168

(57) ABSTRACT

A secure digital memory device comprising a first memory chip, a second memory chip, and a controller. The controller is coupled to the first and second memory chips and operates in an automatic backup mode of the secure digital memory device. In the automatic backup mode, the controller configures the first and second memory chips as main and backup memory partitions respectively. When data is written into the secure digital memory device, the controller writes the data to the main memory partition and into the backup memory partition to serve as backup data.

### BACKGROUND OF THE INVENTION

1. Field of the Invention

The invention relates to a memory device, and in particular to a secure digital memory device with an automatic backup mode.

2. Description of the Related Art

Secure digital memory devices are widely used in portable electronic devices, such personal digital assistants (PDAs), digital cameras, and video players, to serve as data storages. Secure digital memory devices may be small for convenient carry, so that they can be swapped between different systems or different devices to exchange data.

FIG. 1 is block diagram of a conventional secure digital memory device. The secure digital memory device 10 comprises a controller 11, memory chips 12 and 13, and a switch 14. The controller 11 is coupled to the memory chips 12 and 13. A card reader device (not shown in FIG. 1) coupled to the secure digital memory device 10 determines that a storage capacity of the secure digital memory device 10 is equal to the sum of storage capacities of the memory chips 12 and 13. According to the requirements, the card reader device can write data to the secure digital memory device 10, and then the controller 11 writes the data to the memory chip 12 or 13 according to addresses. The switch 14 is a read-only switch and has a first position and a second position. The card reader device can determine the position of the switch 14. When the switch 14 is in the first position, the card reader device can access the secure digital memory device 10 normally. When the switch 14 is in the second position, the card reader device is limited to write data to the secure digital memory device 10 and permitted reading data of the secure digital memory device 10.

Because secure digital memory devices are widely used, improved protection and preservation is desirable.

### BRIEF SUMMARY OF THE INVENTION

Secure digital memory devices are provided. An exemplary embodiment of a secure digital memory device comprises a first memory chip, a second memory chip, and a controller. The controller is coupled to the first and second memory chips and operates in an automatic backup mode of the secure digital memory device. In the automatic backup mode, the controller configures the first and second memory chips as main and backup memory partitions respectively. When data is written into the secure digital memory device, the controller writes the data to the main memory partition and into the backup memory partition to serve as backup data.

Controllers are provided. An exemplary embodiment of a controller is disposed in a secure digital memory device and coupled to a first and second memory chips of the secure digital memory device. The controller comprises a register. When the register stores a first setting value, the controller configures the first and second memory chips as a main and backup memory partitions respectively. When data is written into the secure digital memory device, the controller writes the data to the main memory partition and into the backup memory partition to serve as backup data.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts an conventional secure digital memory device;

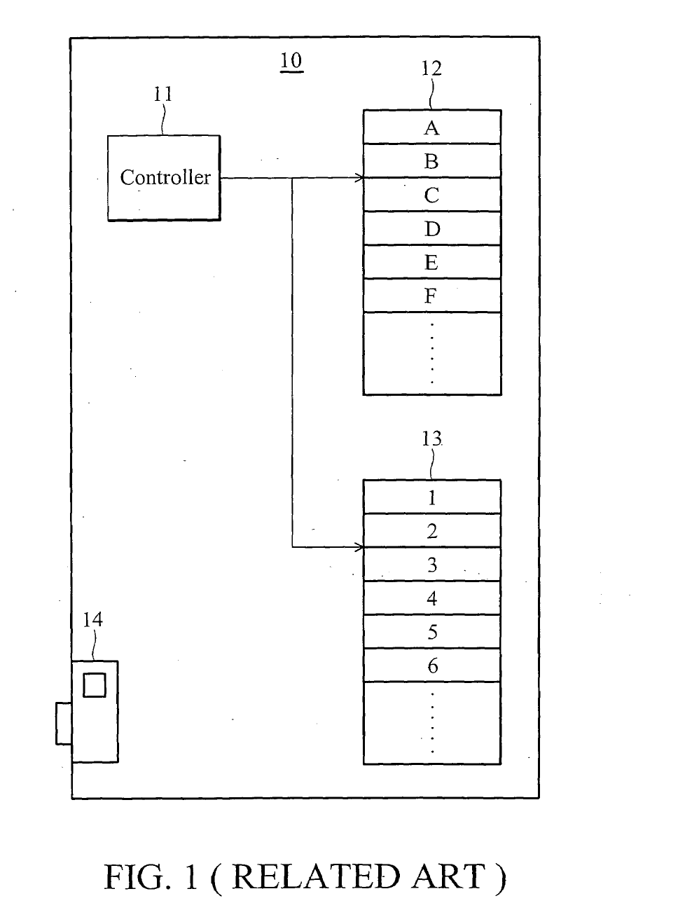

FIG. 2A depicts an exemplary embodiment of a secure digital memory device; and

FIG. 2B is a schematic view showing a normal mode of the secure digital memory device of FIG. 2A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

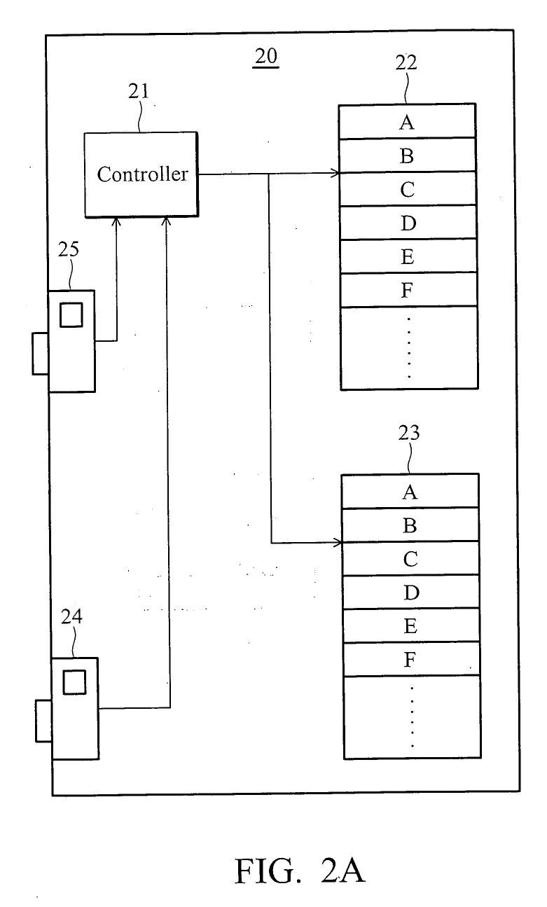

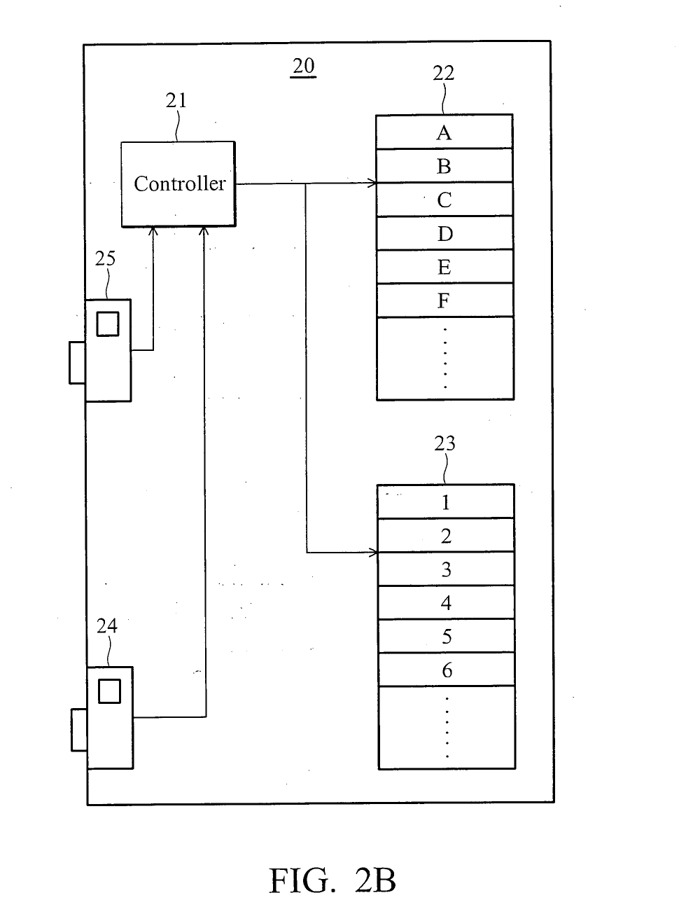

Secure digital memory devices are provided. In an exemplary embodiment of a secure digital memory device in FIG. 2A, a secure digital memory device 20 comprises a controller 21, memory chips 22 and 23, and switches 24 and 25. The controller 21 is coupled to the memory chips 22 and 23.

The secure digital memory device 20 has an automatic backup mode. When the secure digital memory device 20 operates in the automatic backup mode, the controller 21 configures the memory chips 22 and 23 as a main memory partition and a backup memory partition respectively. Storage capacities of the memory chips 22 and 23 are equal, thus the backup memory partition can store the same amount of data as the main memory partition. Thus, the storage capacities of the main and backup memory partitions are set as a smaller of the storage capacities of memory chips 22 and 23. The storage capacities of memory chips 22 and 23 can be the same to avoid wasted memory capacity.

When the secure digital memory device 20 operates in the automatic backup mode, a card reader device (not shown in FIG. 2A) coupled to the secure digital memory device 20 determines that a storage capacity of the secure digital memory device 20 is the storage capacity of the main memory partition. The card reader device writes data to the secure digital memory device 20, and the controller 21 then writes the data to the main memory partition of the memory chip 22 according to addresses. The controller 21 writes the same data to the corresponding positions of the backup memory partition of the memory chip 23 for storing backup data.

The switch 24 is a read-only switch and has a first position and a second position. The card reader device can determine the position of the switch 24. When the switch 24 is in the first position, the card reader device can access the secure digital memory device 20 in a normal manner. When the switch 24 is in the second position, the card reader device is limited to writing data to the secure digital memory device 20 and permitted to read data stored in the secure digital memory device 20.

In this embodiment, a user can selectively read data from the main memory partition or the backup memory partition by using the switch 25. A switch detection device (not shown in FIG. 2A) can be configured in the switch 25 and determines the position of the switch 25. When the switch 25 is in the first position, the switch detection device makes a switch signal coupled to the controller 21 invalid. When the switch is in the second position, the switch detection device makes the switch signal valid. If the switch signal is invalid and the secure digital memory device 20 is to read data, the controller 21 reads the data stored in the main memory partition in response to the read operation. If the switch signal is valid and the secure digital memory device 20 is to read data, the controller 21 reads the data stored in the backup memory partition in response to the read operation.

In this embodiment, the secure digital memory device 20 and functions of conventional card reader devices match up very well. When the switch 24 is in the first position, data is written into the main and backup memory partitions simultaneously, and data is read from the main memory partition. When the switch 24 is in the second position, the card reader device is limited to write data to the secure digital memory device 10 and permitted reading data of the secure digital memory device 20 from the backup memory partition.

The invention may provide improved protection for data stored in a secure digital memory device because the same data is stored in two different memory chips simultaneously. When one of the two memory chips is damaged, the same data can be read from the other undamaged chip.

FIG. 2B is a schematic view showing a normal mode of the secure digital memory device 20. In the normal mode, the secure digital memory device 20 has a larger storage capacity because the memory chips 22 and 23 store different data. In the normal mode, the controller 21 integrates the memory chips 22 and 23 into a normal memory area. The controller 21 receives a control program. The controller 21 switches to the normal or automatic backup mode according to the control program.

The controller 21 further comprises a register (not shown in FIGS. 2A and 2B). The control program writes different setting values to the register to set the controller 21 to operate in the normal or automatic backup mode. The controller 21 performs the normal or automatic backup mode according to the different setting values.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A secure digital memory device, comprising:
a first memory chip;
a second memory chip; and
a controller coupled to the first and second memory chips and operating in an automatic backup mode of the secure digital memory device;
wherein, in the automatic backup mode, the controller configures the first and second memory chips as main and backup memory partitions respectively; and
wherein, when data is written into the secure digital memory device, the controller writes the data to the main memory partition and into the backup memory partition to serve as backup data.

2. The secure digital memory device as claimed in claim 1, wherein the controller further operates in a normal mode of the secure digital memory device, and the controller integrates the first and second memory chips into a normal memory area in the normal mode.

3. The secure digital memory device as claimed in claim 2, wherein the controller receives a control program and is switched to the normal or automatic backup mode according to the control program.

4. The secure digital memory device as claimed in claim 1, wherein the controller is coupled a switch signal, and in the automatic backup mode:
if the switch signal is invalid and the secure digital memory device is desired to read data, the controller reads the data in the main memory partition; and
if the switch signal is valid and the secure digital memory device is desired to read data, the controller reads the data in the backup memory partition.

5. The secure digital memory device as claimed in claim 4 further comprising:
a switch having a first and second positions; and
a switch detection device for determining a position of the switch;
wherein, when the switch is in the first position, the switch detection device makes a switch signal invalid; and
wherein, when the switch is in the second position, the switch detection device makes the switch signal valid.

6. A controller disposed in a secure digital memory device and coupled to a first and second memory chips of the secure digital memory device, and the controller comprising a register;
wherein, when the register stores a first setting value, the controller configures the first and second memory chips as a main and backup memory partitions respectively; and
wherein, when data is written into the secure digital memory device, the controller writes the data to the main memory partition and into the backup memory partition to serve as backup data.

7. The controller as claimed in claim 6, wherein when the register stores a second setting value, the controller integrates the first and second memory chips into a normal memory area.

8. The controller as claimed in claim 7, wherein the controller receives a control program to change a setting value of the register to the first or second setting value.

9. The controller as claimed in claim 6, wherein controller is coupled a switch signal, and when the register stores the first setting value:
if the switch signal is invalid and the controller is desired to read data, the controller reads the data in the main memory partition; and
if the switch signal is valid and the controller is desired to read data, the controller reads the data in the backup memory partition.

10. The controller as claimed in claim 6 further comprising:
a switch detection device coupled to a switch of the secure digital memory device for determining a position of the switch;
wherein, the switch has a first and second positions;
wherein, when the switch is in the first position, the switch detection device makes a switch signal invalid; and
wherein, when the switch is in the second position, the switch detection device makes the switch signal valid.
